(19) United States
(12) Patent Application Publication
(10) Pub. No.: US 2013/0275149 A1
(43) Pub. Date: Oct. 17, 2013

(54) CLINICAL QUALITY ANALYTICS SYSTEM

(71) Applicants: Daniel Adam Gaines, Sudbury, MA (US); Mark A. Knickrehm, Rancho Santa Fe, CA (US); Kenneth Webb, San Francisco, CA (US); Leilei Byl, Portland, OR (US)

(72) Inventors: Daniel Adam Gaines, Sudbury, MA (US); Mark A. Knickrehm, Rancho Santa Fe, CA (US); Kenneth Webb, San Francisco, CA (US); Leilei Byl, Portland, OR (US)

(73) Assignee: Accenture Global Srvices Limited, Dublin (IE)

(21) Appl. No.: 13/496,230

(22) PCT Filed: Dec. 30, 2011
(86) PCT No.: PCT/US11/68177

§ 371 Date: Mar. 15, 2012

Related U.S. Application Data
(60) Provisional application No. 61/428,636, filed on Dec. 30, 2010.

(51) Int. Cl. G06Q 10/06; G06Q 50/24

(52) U.S. Cl. CPC G06Q 10/06393; G06Q 50/24
USPC 705/3

(57) ABSTRACT

A clinical quality analytics (CQA) system includes a process map toolset, which determines a process map from a protocol for medical treatment guidelines. A mapping module maps formats electronic medical record (EMR) data, which is mapped to the process map. A measurement and evaluation module determines metrics to evaluate a quality of care associated with the protocol and determines a population of the EMR data to use for the evaluation. A CQA engine evaluates the population of EMR data for compliance with the protocol based on the metrics and the process map.

### PRIORITY

The present application claims priority to U.S. provisional patent application Ser. No. 61/428,636, filed Dec. 30, 2010, which is incorporated by reference in its entirety.

### BACKGROUND

In an organization providing medical care, records are often kept in the form of electronic medical records (EMRs). For example, a physician may enter notes into a computer to make them part of an EMR for a patient, or the notes are entered on a chart or are audio recorded and later transcribed and entered to become part of an EMR. The EMRs may be stored in a database and retrieved for reporting.

The reporting on the EMRs tends to be rudimentary. For example, EMRs may be viewed on a patient-by-patient basis, such as to view the existing data on the care previously provided to the patient. In some cases, reports may be generating on an aggregate level to view information on multiple patients. However, in many instances, this aggregate level of reporting is insufficient to understand the level of care being provided by an organization or to understand how to improve the quality of care. Part of the cause is that much of the data entered into the EMRs is text taken from caregiver's notes or dictations, which is difficult to quantify or report at an aggregate level.

In addition, in recent years, hospitals and other health care provider organizations have adopted evidence based clinical treatment guidelines as a part of their clinical quality programs. These guidelines are promulgated by a broad variety of health organizations, experts and industry authorities associated with specific medical specializations. These clinical treatment guidelines are utilized to diagnose and provide care for various illnesses, and in many instances hospitals and other caregivers utilize the guidelines to provide care. Many existing EMR systems are lacking in their ability to use EMRs to evaluate whether the guidelines are being followed or whether the guidelines are effective in improving care.

### BRIEF DESCRIPTION OF THE DRAWINGS

Embodiments are described in detail in the following description with reference to the following figures. The embodiments are illustrated by way of example and are not limited in the accompanying figures in which like reference numerals indicate similar elements.

FIG. 1 illustrates a Clinical Quality Analytics (CQA) system, according to an embodiment;

FIGS. 2-11 illustrate screenshots which may be generated by the CQA system, according to an embodiment;

FIG. 12 illustrates a flowchart of a method for evaluating compliance with a medical protocol, according to an embodiment; and

FIG. 13 illustrates a computer system that is operable to be used for the CQA system, according to an embodiment.

### SUMMARY

According to an embodiment, a clinical quality analytics (CQA) system may include a process map toolset to determine a process map from a protocol for medical treatment guidelines. The CQA system may include a mapping module to format electronic medical record (EMR) data to map the formatted EMR data to the process map. The CQA system may include a measurement and evaluation module to determine metrics to evaluate a quality of care associated with the protocol and to determine a population of the EMR data to use for the evaluation, and a CQA engine to evaluate the population of EMR data for compliance with the protocol based on the metrics and mapping of the formatted EMR data in the population to the process map.

According to another embodiment, a method of evaluating compliance with a protocol for medical treatment guidelines may include receiving the protocol for medical treatment guidelines; determining a process map from the protocol; formatting electronic medical record (EMR) data; determining metrics to evaluate the quality of care associated with the protocol; determining a population of the EMR data to use for the evaluation; and evaluating, e.g., by a processor, the population of EMR data for compliance with the protocol based on the metrics and based on a mapping of the formatted EMR data in the population to the process map.

The method and other functions described herein may be embodied as machine readable instructions on a non-transitory computer readable medium. The instructions may be executed by a processor or computer system to perform the method or functions.

### DETAILED DESCRIPTION OF THE EMBODIMENTS

For simplicity and illustrative purposes, the principles of the embodiments are described by referring mainly to examples thereof. In the following description, numerous specific details are set forth in order to provide a thorough understanding of the embodiments. It is apparent however, to one of ordinary skill in the art, that the embodiments may be practiced without limitation to these specific details. In some instances, well known methods and structures have not been described in detail so as not to unnecessarily obscure the description of the embodiments. Furthermore, different embodiments are described below. The embodiments may be used or performed together in different combinations.

According to an embodiment, a Clinical Quality Analytics (CQA) system comprises a toolset to render a protocol, such as an industry clinical treatment guideline, into a process map. A process map may comprise a workflow that can be visualized on a display. The workflow comprises steps generated from the protocol, for example, using the toolset. The workflow may comprise a time-based series of steps determined from the protocol to render care according to guidelines specified in the protocol. The toolset is operable to associate metrics with the steps, such as location and caregiver identity.

The CQA system is also operable to associate data from EMRs with particular steps in the process map, and based on the association, determine protocol compliance metrics. Reports may be generated to specify the compliance metrics and provide additional information related to measuring the quality of care and improving the quality of care. Also, prescriptive and predictive analytics may be performed on the data from EMRs or data derived from the EMRs to determine how to modify the process map to improve quality of care.

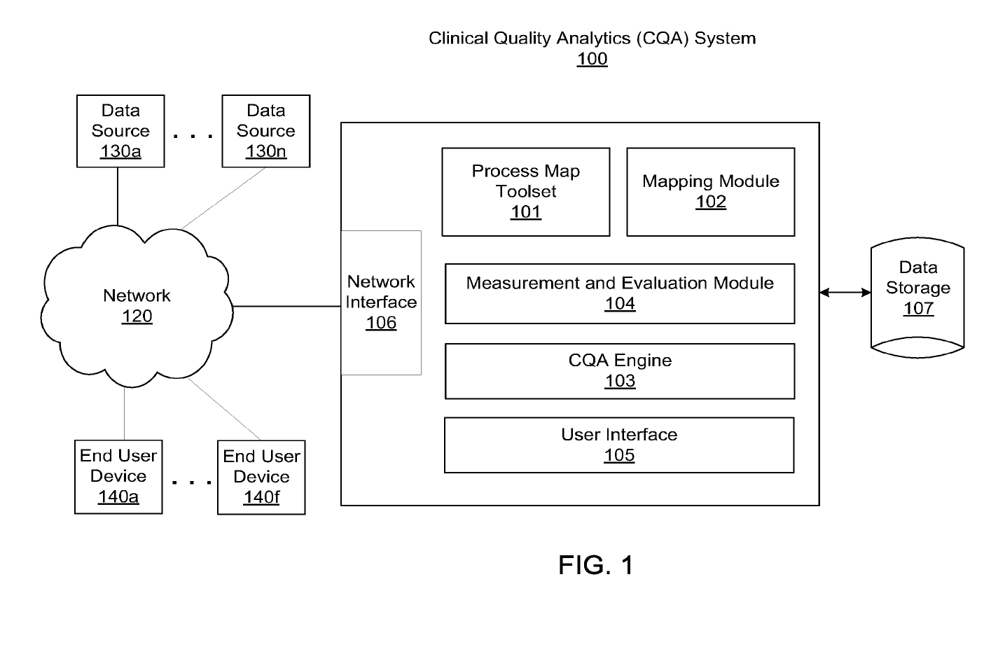

FIG. 1 illustrates a CQA system 100, which may be connected to a network 120. Data Sources 130a-n are shown. The CQA system 100 may receive protocols, EMRs, and other information from the data sources 130a-n, for example, via the network 120. The data sources 130a-n may comprise electronic medical systems capturing medical data and generating EMRs from the medical data. The data sources 130a-n may comprise systems publishing protocols and other medical information. End user devices 140a-f are shown. The end user devices 140a-f may connect to the CQA system 100 to enter data and view compliance reporting and other information generated by CQA system 100. Although not shown, one or more of the data sources 130a-n and the end user devices 140a-f may be connected to the CQA system 100 through a direct link, rather than a network. For example, the CQA system 100 may be part of an electronic medical system that generates EMRs and includes the CQA system 100. Also, the CQA system 100 may include I/O devices, such as a display, keyboard, mouse, etc., that allows users to enter and view data.

The CQA system 100 includes a process map toolset 101, a mapping module 102, a CQA engine 103, a measurements and evaluation module 104, a user interface 105 and a network interface 106. Also, a data storage 107 is connected to the CQA system 100 to store any information used by the CQA system 100, such as EMRs, protocols, process maps, reports, etc. The data storage 107 may include a database or other type of storage system. The network interface 106 connects the CQA system 100 to the network 120. The user interface 105 may include a graphical user interface (GUI), which may be viewed on a display connected to the CQA system 100 or viewed on the end user devices 140a-f via network 120, which may include the Internet. The components of the CQA system 100 may comprise computer hardware, software or a combination.

The process map toolset 101 generates process maps from protocols, which may be published be medical experts, health organizations or other entities. The protocols are medical related and may include treatment guidelines for various illnesses or medical conditions. The process map toolset 101 provides a workspace that presents a protocol for example received from a health organization, and provides tools for generating a process map from the protocol. The protocol may be provided as text in a document. Information from the protocol may be extracted to generate a protocol outline. A user may use tools provided by the process map toolset 101 to generate a process map from the protocol and protocol outline. The workspace provided by the process map toolset 101 may comprise an editor and other features described in further detail below.

The mapping module 102 maps information from EMRs to the process map. The EMRs may include information, such as lab results, vitals (e.g., measurements of patient vital functions which may be performed by a nurse or machine), orders for tests, physician notes, etc. The mapping module 102 may format data from EMRs into a temporal process model. For example, the mapping module 102 extracts essential EMR data from the EMRs and organizes the data to create a temporal process model. The EMR data in the model may represent information about patient events associated with the medical care provided to the patients. The temporal process model may have a schema for organizing the extracted EMR data based on attributes (e.g., time, location, caregiver, etc.) of the data and based on predetermined categories. EMR data in the model may then be quickly searched for mapping the data to one or more process maps, for example, by the CQA engine 103, as described below.

The measurement and evaluation module 104 defines the analytic views that may be generated by the CQA system 100, and determines the KPI's and other metrics that are available to analyze the quality of care associated with the protocol. The CQA engine 103 determines values for the metrics which may be identified from the EMR data or calculated from the EMR data. Metrics may be customized by the user. The measurement and evaluation module 104 may also define data elements for data mining. For example, keywords that are relevant to a process map are identified and stored as data elements. The keywords may then be used for mining information from unstructured data in the EMRs, which can be used to map EMR data to the process map.

The CQA engine 103 maps EMR data, for example from the temporal process model, to the process map. The mapping may include pattern recognition techniques to match EMR data in the temporal process model to steps in the process map. Rule based or analytical based classifiers may be used to match EMR data with steps in the process map. Also, the mapping module 102 may perform data mining, for example according to defined data elements, on the EMR data to match EMR data with steps in the process map. The CQA engine 103 may generate reports based on the metrics and the mapping, which may be viewed through the user interface. The reports may identify when the quality of care falls short of guidelines and may be used to detect metrics associated with the causes, such as where, when, how and by whom.

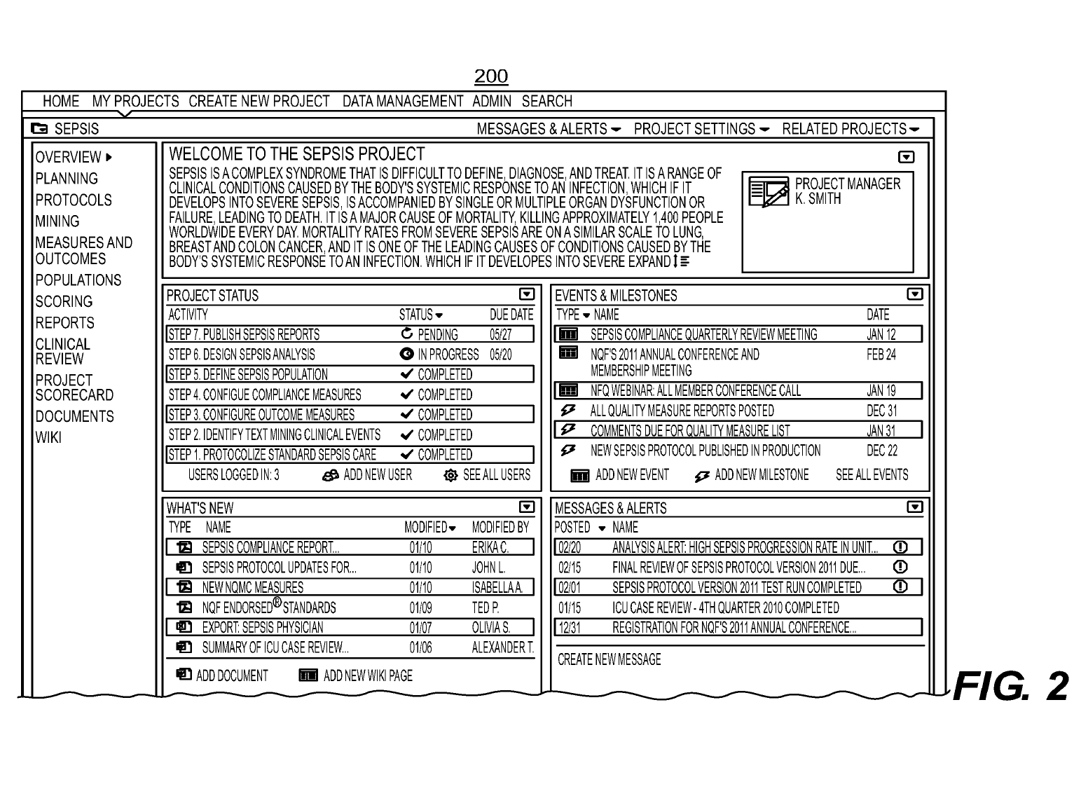

FIGS. 2-11 show examples of screenshots generated by the CQA system 100, for example, via the user interface 101 that illustrates various functions of the CQA system 100.

In one example, the CQA system 100 is used to map a protocol for sepsis. Sepsis is a complex medical syndrome that is difficult to define, diagnose and treat. FIG. 2 shows a screenshot 200 of an overview for a sepsis project that may be created in the CQA system 100 to monitor compliance of quality of care provided to patients for a sepsis protocol. The screenshot 200 includes a project status that illustrates the steps performed with the CQA system 100 and their completion status. The steps include steps performed by the CQA system 100 including standardizing a protocol for sepsis to create a process map from the protocol; text mining clinical events in EMR data to map the clinical events to the steps in the process map; configuring outcome and compliance measures for evaluating compliance with the protocol and overall quality of care; and defining a population of patients and sepsis analysis from the measures to generate reports. Other sections of the screenshot 200 show events and milestones for the project, messages and alerts and new documents added to the project. The events and milestones show the publication of a sepsis protocol which may be received and stored in the data storage 107 and may be used to create a process map for the sepsis protocol.

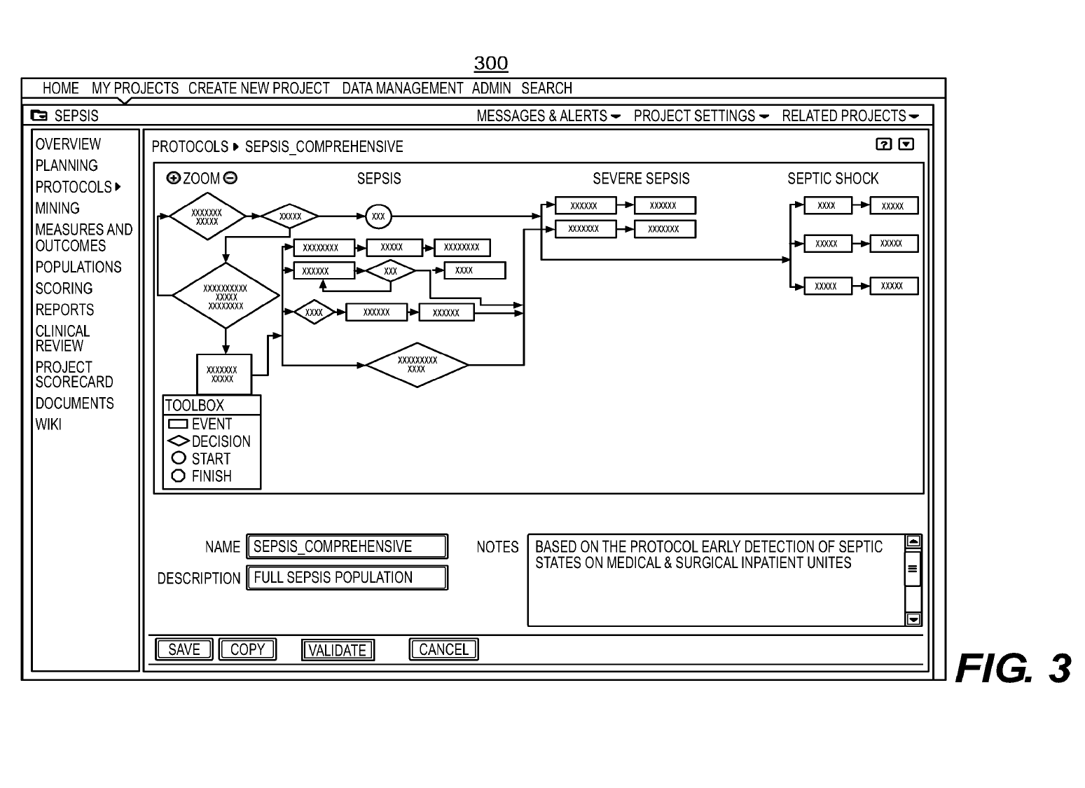

FIG. 3 shows a screenshot 300 of creating a process map from the sepsis protocol. The process map is labeled Sepsis_Comprehensive and is generally divided into three section comprising Sepsis, Severe Sepsis and Septic Shock. In each section is the workflow that is created from the protocol. The workflow includes steps, which may include decision steps, such as shown as diamonds, or event steps, shown as rectangles, circles or other shapes. The workflow is a time-based series of steps for providing care for patients that may have sepsis. The steps may include steps for diagnosing, measuring vitals, ordering tests, lab results, or any steps that may be used in providing of care for a septic patient. Time-based means the steps are followed in the sequence as shown to provide care. The process map may include more than one path that can be followed at the same time, so some steps may be performed simultaneously or substantially in parallel.

The process map toolset 101 provides a workspace for creating the process map based on the sepsis protocol. The workspace may include an editor as shown in FIG. 3. For example, a user can add, remove or modify steps in the process map through the editor. Then, the process map can be validated, saved and copied as needed. The process map toolset 101 may generate an initial process map from the protocol. For example, text mining may be used to identify a series of steps from a published protocol and an initial process map is generated from the identified steps. The initial process map is shown in the editor, and a user may modify the process map as needed.

Each step in the process map has attributes. Some of the attributes may include event type, time, location and caregiver. For example, one of the step in the process map is for the physician to order a lactic acid test every four hours. The attributes may include an event type, such as physician order. A location may include the department the physician works in. The time may indicate when in the process map the physician is to perform the event of ordering this test. Other attributes may include event subtype, such as laboratory, and order frequency, such as every four hours. Result component, such as lactic acid, is another attribute that may be used for the laboratory event subtype. Attributes for steps may be entered by a user and may be displayed by clicking on a step in the process map.

After the process map is generated and stored, the mapping module 102 maps EMR data from EMRs to the events in the process map. For example, EMRs may be collected over a period time. The EMRs may be from a single entity, such as from a single hospital or physician's office, or may be from multiple entities. The EMRs may include some structured data, such as the identity of the caregiver and a time and date of performing a medical event. The EMR data may include unstructured data, such as text entered by a physician or nurse or lab describing the care given or lab results.

The mapping module 102 extracts data from the EMRs and aligns its temporally so it aligns with the events in the process map. The mapping module 102 also extracts attributes from the EMRs that coincide with the attributes stored in the process map. The mapping module 102 organizes the EMR data temporally so it aligns with the process map and stores the attributes with the aligned data to create a temporal process model of patient care representing the essential information about the patient events associated with the medical care provided to the patients.

The CQA engine 103 matches information in the temporal process model to the events in the process map. The matching process may include identifying the starting point in the clinical record of the EMR data from the transformed model for the protocol, and then matching the EMR data from the starting point to the process map. For example, the EMR data for the starting point of the protocol is matched with an event or group of events in the starting point of the process map. Then, the matching process continues following the workflow of the process map. Matching may include matching attributes of the EMR data to the attributes of the events in the process map. Rule-based or analytical based artificial intelligence classifiers may be used to classify EMR data as belonging to a particular event in the process map.

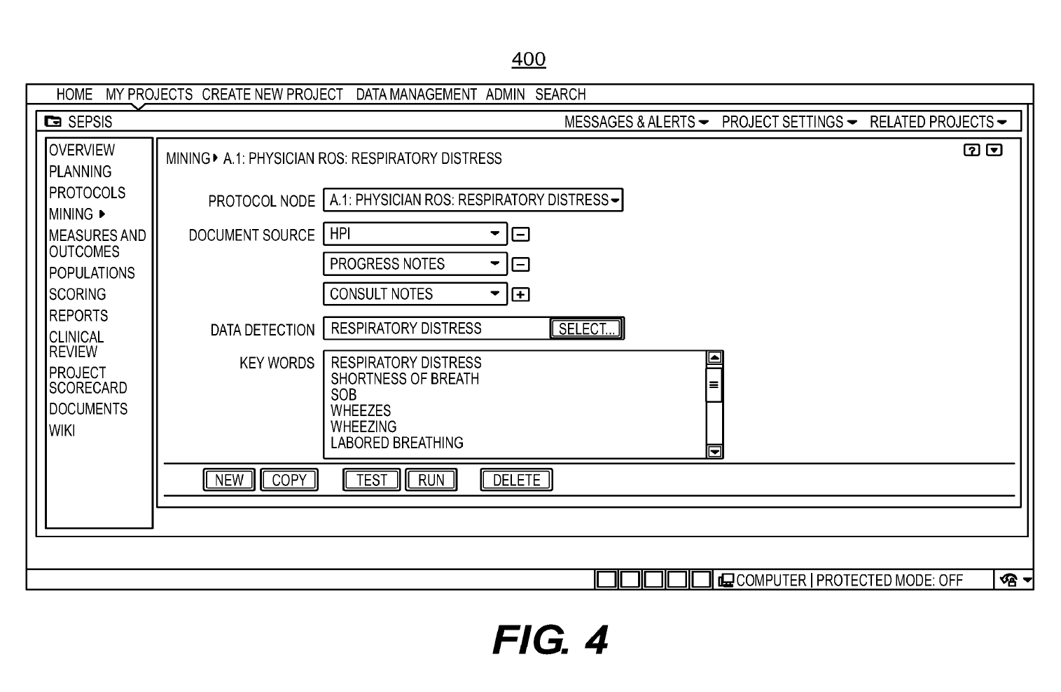

Data mining may be performed to extract attributes of the EMR data from the textual information in the EMR data. The text may include notes or other information entered by a caregiver, for example, in an unstructured format. FIG. 4 shows a screenshot 400 for entering data elements that may be used for text mining in order to extract data from a particular event in the process map. As shown in FIG. 4, the event from the process map is selected. Event is shown as “Protocol Node”. In this example, the selected event is “A.1 Physician ROS: Respiratory Distress”. This event A.1 may be a step in the process map for determining whether a patient has respiratory distress. The determination may be performed along with other steps to determine whether a patient qualifies a subsequent assessment.

Determination of respiratory distress may not be specified in structured data of EMRs. Instead, it may be specified in the text in notes in the EMRs or in other information. In the screenshot 400, the document source is selected, which may include EMR data or other information. HPI is selected which stands for history of present illness. Other documents that are selected are physician progress notes and consult notes. These documents are searched to identify whether the patients had respiratory distress.

A dictionary may be used to determine key words for describing respiratory distress. One or more of the keywords may be selected, and the EMR data is searched using the keywords to determine EMR data matches this process map event.

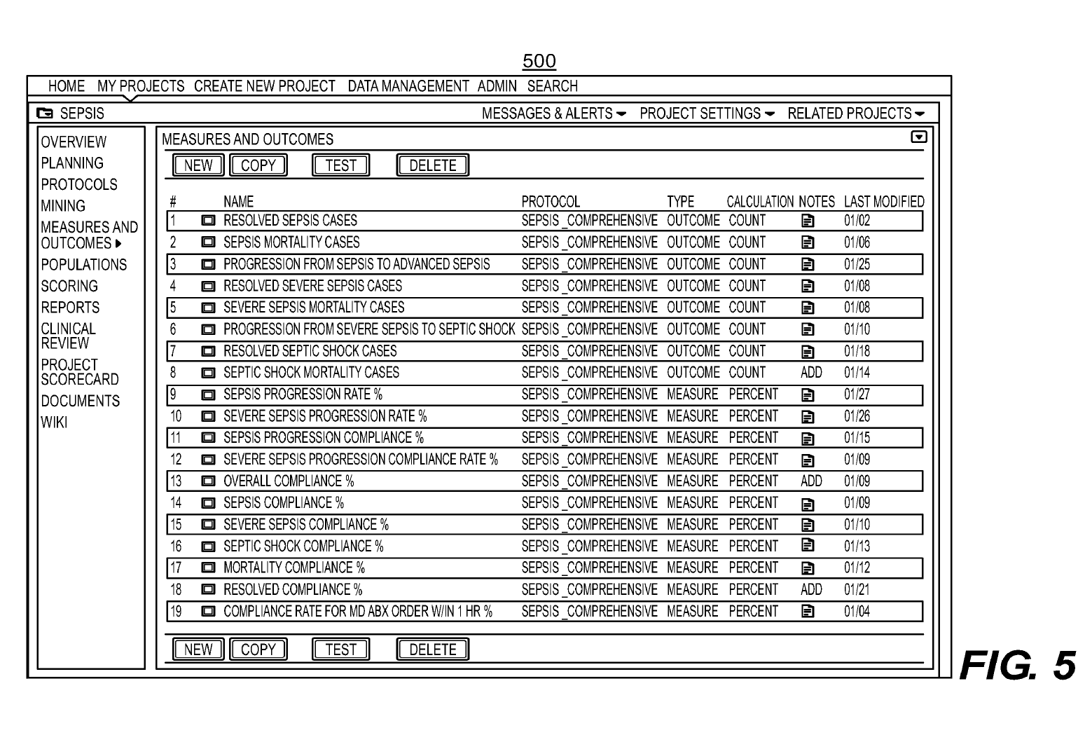

The measurement and evaluation module 104 defines the analytic views that may be generated by the CQA system 100, and determines the KPI's and other metrics that are available to analyze the quality of care associated with the protocol. FIG. 5 shows an example of metrics that be selected for analyzing the quality care provided around the sepsis protocol. The metrics identify the protocol or process map that is relevant, the type of metric (e.g., measurement or outcome), the calculation for determining the metric, notes and modification date.

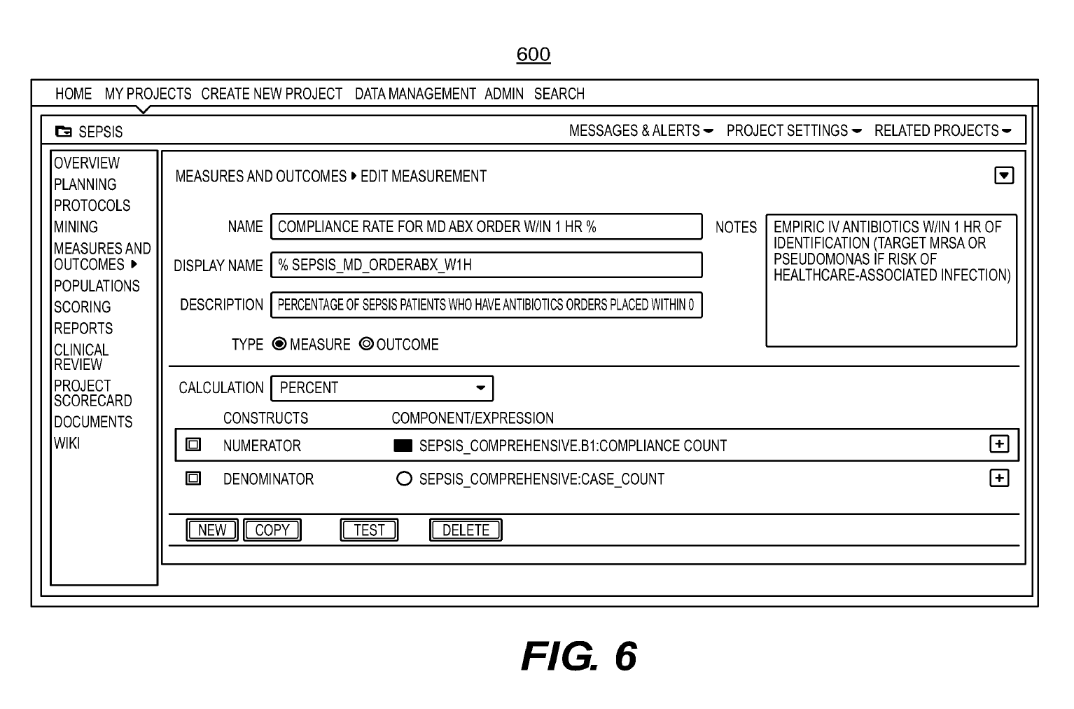

FIG. 6 shows a screenshot 600 for defining a metric. In this example, the metric is a compliance rate for an antibiotic order within the first hour. The metric is defined by specifying a name, display name and description, and specifying how the metric is calculated. In this example, the metric is defined as a percentage. The numerator is defined as the number of cases that comply with event node B1, which is the antibiotic order, and the denominator is defined as the number of cases that entered the comprehensive sepsis protocol.

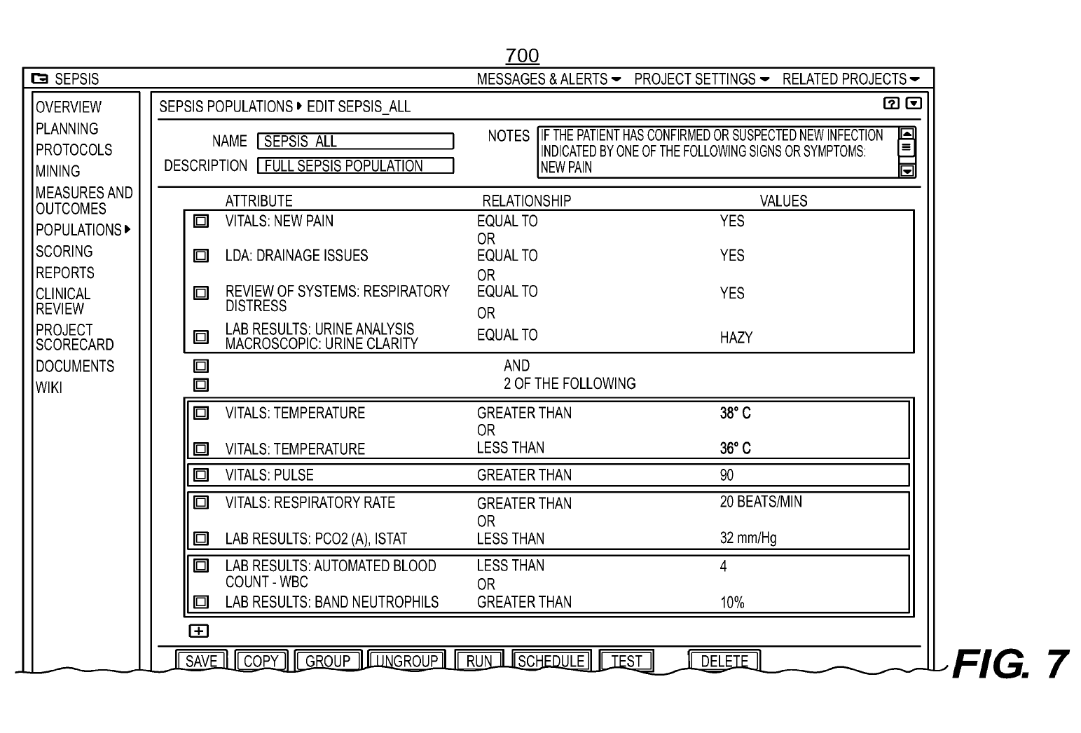

In addition to determining metrics, KPIs and analytic views, the measurement and evaluation process performed by the CQA system 100 includes determining a population or the set of cases to be evaluated. FIG. 7 shows a screenshot 700 for selecting filters to identify the population of cases. The EMR data may include EMRs for millions of patients that were provided care for a variety of illnesses. In this example, filters are set to identify EMRs for patients that are suspected of having sepsis. The filters may include attributes and a value for each value and the relationship between the attribute and value. For example, filters may be selected in the screenshot 700 to identify all the cases where the patients have a vital sign of new pain=yes; a drainage issue=yes; respiratory distress=yes; lab results for urine analysis=hazy and any two of the filters shown in the bottom half of the screenshot 700. The filters may be combined through logic (e.g., AND, OR) to select the population. Also, a set of filters may be predetermined, such as shown in the screenshot 700, and some of the filters from the set are selected to identify the population. In many instances, EMR data gathered from the data mining process described above is compared to the filters to determine whether cases from the EMR data should be part of the population to be evaluated for compliance with the protocol. The EMR data is filtered by the selected filters to determine the population. Filtering may include determining EMR data that complies with filter conditions.

Once the population is identified, the CQA engine 103 evaluates the population of cases to determine compliance with the protocol based on the metrics defined and selected. The CQA engine 103 may generate scores and reports to indicate compliance and variances from compliance and to provide analytic views to identify problems with particular individual caregivers, particular departments, particular shifts (e.g., day shift versus night shift), etc.

The analytic views generated by the CQA system 100 allow drill downs which may be used to identify the cause of problems. For example, an initial view may comprise a color-coded display of the process map. An event shown in red or yellow indicates a high-level or medium-level of variance from the protocol. A user may click on a red event to drill down to additional information, such as compliance metrics for the department responsible for the event. Another drill down may include the metrics for the shifts for the department. Once a problematic shift is identified, another drill down may include compliance metrics for individuals in the shift. Then, remedies may be determined, such as additional training for individuals not adhering to the protocol. In another example, the metrics may identify that the protocol is not being followed during a shift change, so new internal shift change procedures for the department may be specified as a remedy.

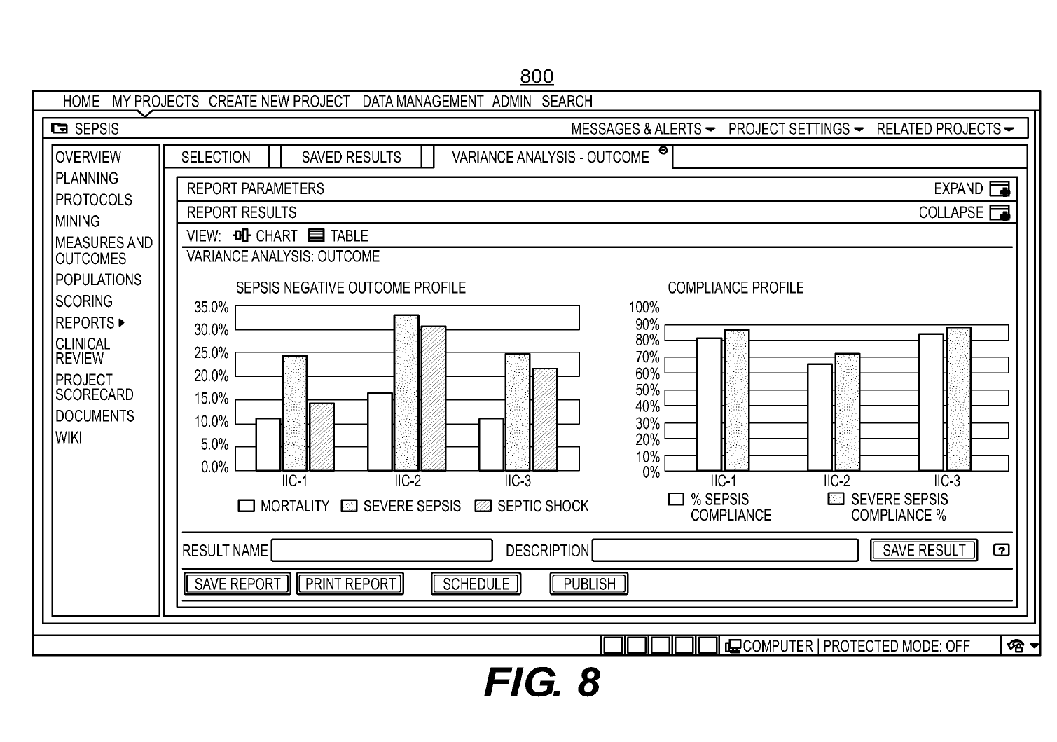

FIGS. 8-11 show examples of screenshots of reports generated by CQA system 100 based on comparisons performed by the CQA analytics engine 103. The reports may be based on the metrics defined and selected for the protocol. FIG. 8 shows a screenshot 800 of an example of an overall compliance report for the sepsis protocol. The screenshot 800 shows an outcome profile and a compliance profile. The profiles indicate the percentage of compliance for categories of the population.

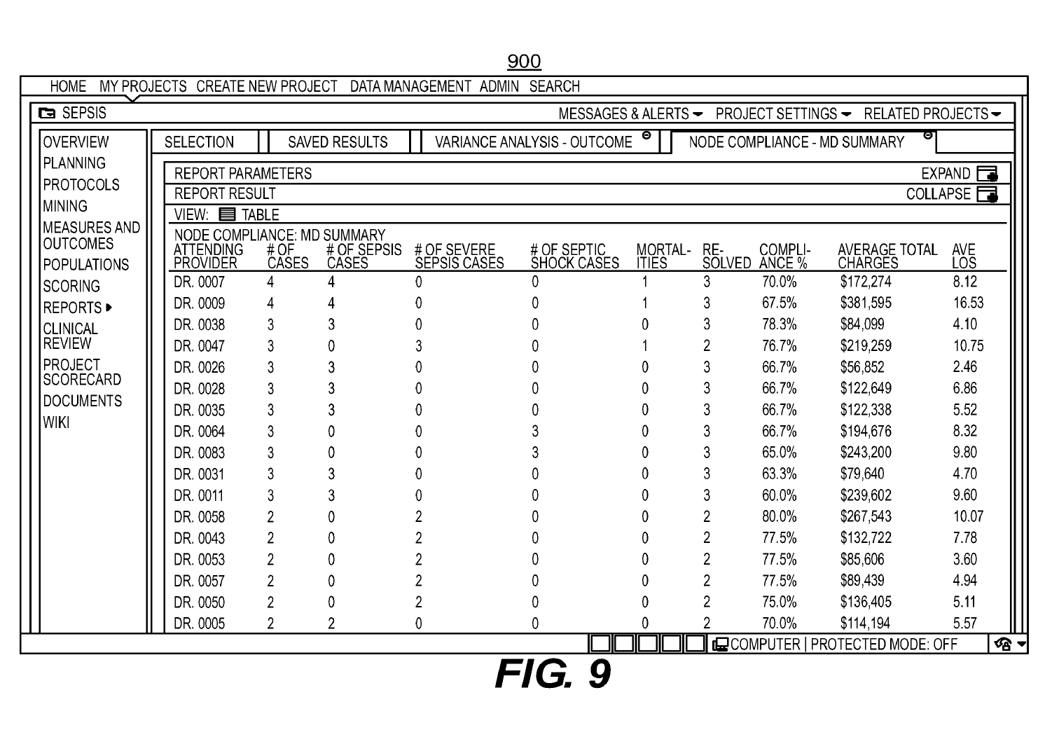

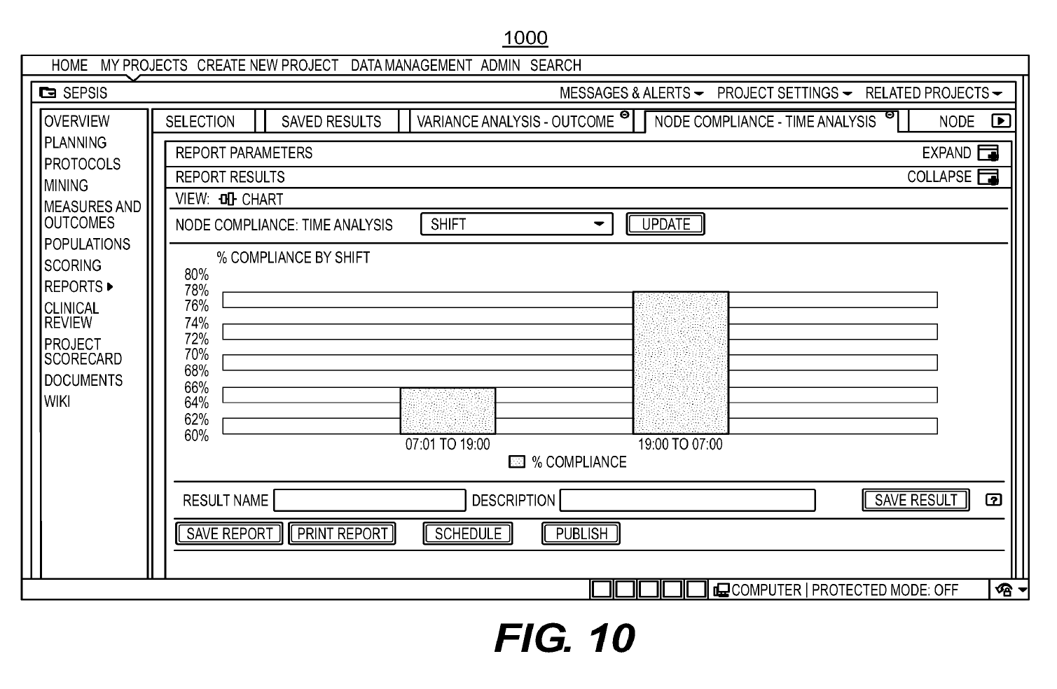

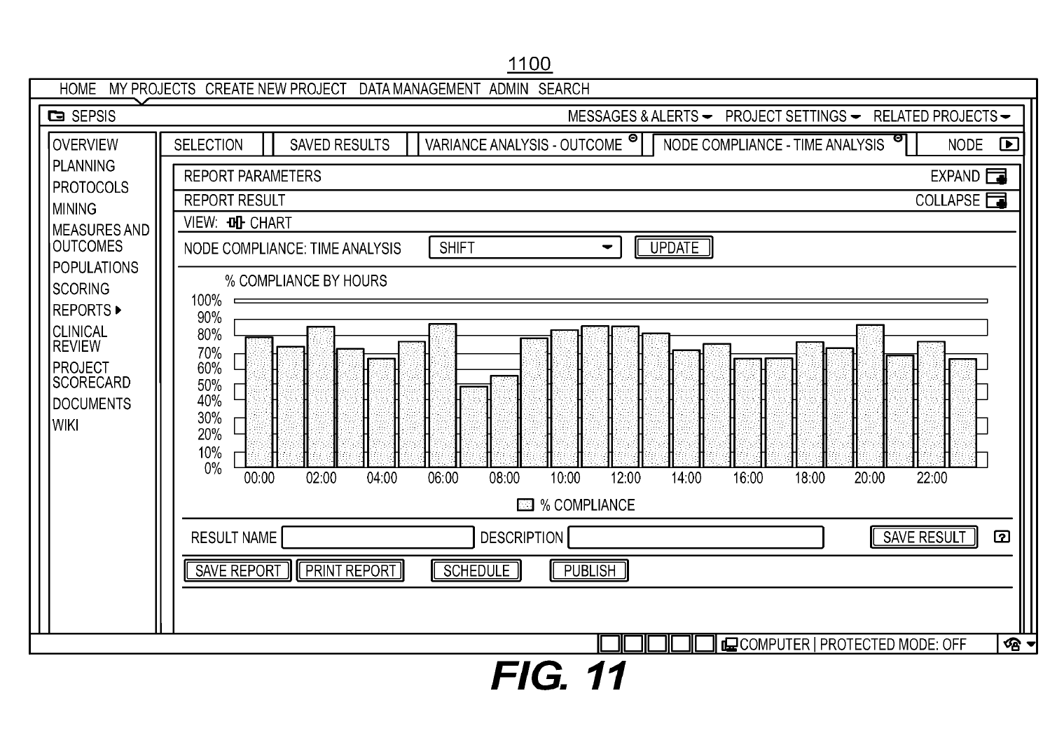

FIG. 9 shows a screenshot 900 of node compliance. In this example, the nodes are physicians. The report indicates the metrics for each physician including percentage of compliance and average total cost. This report may be used to identify physicians that are not complying or that are over-priced. FIGS. 10 and 11 show screenshots 1000 and 1100 providing reports of compliance percentages by shift. These reports may be used to evaluate compliance metrics on an hourly basis. The reports in the screenshots 900-1100 may be used as part of a drill down process to identify root causes of poor quality of care as it relates to the protocol.

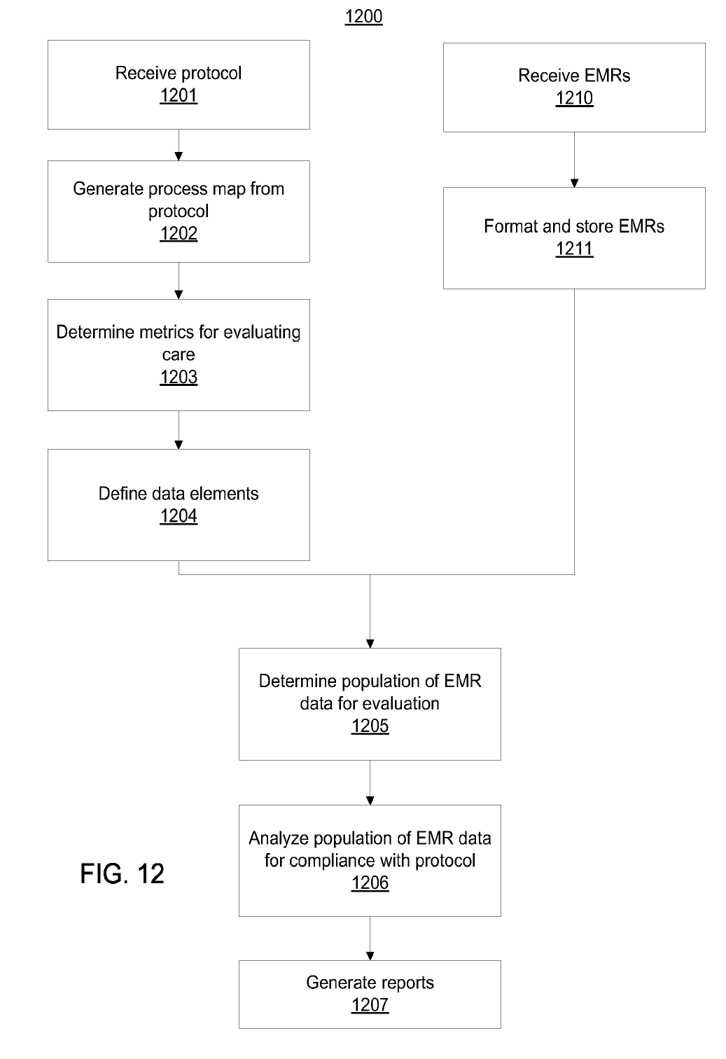

FIG. 12 illustrates a method 1200, according to an embodiment. The method 1200 is described with respect to the CQA system 100 shown in FIG. 1 by way of example and not limitation. The method 1200 may be performed by other systems.

At 1201, a protocol is received. For example, the CQA system 100 receives a protocol from data source 130a, which may be a health organization. The protocol may be a document published on the Internet that specifies treatment guidelines for a medical condition. The CQA system 100 may download the document. The protocol is stored in the data storage 107.

At 1202, a process map is generated from the protocol. The process map comprises a workflow that can be visualized on a display. The workflow may comprise a time-based series of events (e.g., steps) determined from the protocol to render care according to guidelines specified in the protocol. The process map toolset 101 is operable to associate attributes with the events, such as event type, location, caregiver identity, event subtype, order frequency, result component, etc. The attributes may also include a time attribute that identifies when the event should take place in the workflow of the process map. The process map is stored for example in the data storage 107 shown in FIG. 1.

The process map toolset 101 provides a workspace for creating the process map based on, for example, the sepsis protocol, where a user may interact with the process map and add, remove or modify steps in the process map through an editor. FIG. 3 shows an example of at least a portion of a process map. The process map toolset 101 may generate an initial process map from the protocol, for example, by identifying a series of steps from a published protocol and generating an initial process map from the identified steps. The process map is displayed and a user may modify the process map as needed.

The process map toolset 101 stores attributes for each event in the process map. Attributes for events may be entered by a user and may be displayed by clicking on a step in the process map.

At 1203, metrics, including KPI's, are determined to analyze the quality of care associated with the protocol. The metrics may be selected and/or defined by a user. For example, the measurement and evaluation module 104 may store a predetermined set of metrics for a protocol and present these metrics to a user. The user may select one or more of the metrics or define new metrics for the evaluation.

At 1204, data elements are defined. The data elements may be used for data mining to map EMR data to the process map. For example, the data elements may include keywords related to steps in the process map, such as “lactic acid test”, “respiratory distress”, etc. These keywords may be used by the CQA engine 103 to search EMR data and map EMR data to the process map, for example, at 1206 described below. FIG. 4 shows the screenshot 400, which may be used for defining data elements.

At 1210, EMRs are received. The EMRs may be received from the data sources 130a-n shown in FIG. 1. At 1211, the EMRs are formatted and stored, for example, in the data storage 107. Formatting may include extracting data from the EMRs and storing the data in a format that allows the data to be searched for evaluation against one or more process maps. The extracted data may include attributes and other information extracted from structured and unstructured portions of the EMRs. For example, the mapping module 102 extracts attributes from the EMRs that coincide with the attributes stored in the process map. For example, the attributes extracted from the EMRs may include a time a patient encounter took place. A patient encounter may include one or more actions or events that occur when providing care to a patient. Another attribute may include a location of the patient encounter. Another attribute may include categorizing a patient encounter and data associated with the patient encounter in an event type, such as observation, intervention, medical concern type, etc. Other attributes may include event subtype, caregiver identity, etc.

The data extracted from the EMRs is organized and stored so it may be searched across one or more of the attributes. For example, the mapping module 102 organizes the EMR data to create a temporal process model from the extracted data, which represents the essential information about the patient events associated with the medical care provided to the patients. The temporal process model may include a schema representing the extracted attributes.

Extracting the data from the received EMRs may include extracting data from structured and unstructured portions of the EMRs. The received EMRs may include structured data stored in predetermined fields that may correspond to fields in the temporal process model. For the unstructured data, data mining may be performed to extract attributes from the textual information. For example, a determination of whether a patient has respiratory distress may not be specified in structured data of EMRs. Instead, it may be specified in notes or documents in the EMRs or in other information. The text is searched to identify whether the patients had respiratory distress. This information is extracted and may be stored under the observation event type in the process model, along with time and location and other attributes for the observation. The searching of the text may be part of the data mining process. The data mining may include using key words specified by a user.

The steps 1210 and 1211 may be continually performed. For example, EMRs are formatted and stored when received or in batches. Process maps may be generated according to steps 1201 and 1202 as needed.

At 1205, a population of EMR data is determined for evaluation against the process map performed at 1205. For example, the measurement and evaluation module 104 may present filters to a user to select the population. The filters may be modified and stored. Filtering may include determining EMR data that complies with filter conditions.

At 1206, the population of EMR data is evaluated for compliance with the process map generated at 1202. The evaluation may be based on the metrics determined at 1203. Evaluation may include comparing EMR data from the population to each event in the process map. For example, the formatted EMR data from 1211 that is in the population determined at 1204 is analyzed by the CQA engine 103 to map the formatted EMR data from the population to events in the process map. For example, an event in the process map may indicate a physician is to check for respiratory distress at a certain point in the workflow of the process map. Another example of an event in the process map may be that a lactic acid test is to be ordered or performed every four hours starting at a certain point in the process map workflow. The CQA engine 103 determines whether these events were performed at the proper times in the timeline of the care provided to patients by searching the formatted EMR data.

In one example, the mapping process may include the CQA engine 103 matching information in the formatted EMR data to events in the process map. Matching may include matching attributes of the formatted EMR data to the attributes of the events in the process map. The matching may be performed starting from an event at the beginning of the process map to identify EMR data for the event. Then the matching process continues for other events following the workflow of the process map. The mapping process may utilize the data elements defined at 1204 to match EMR data with events in the process map. For example, the data elements may include keywords that are used to mine the formatted EMR data to identify EMR data relevant to each event in the process map.

The matching formatted EMR data may be compared with the corresponding events in the process map to determine if medical care according the process map was being provided to patients. For example, the comparison may determine whether respiratory distress was checked for patients at the proper time or whether lactic acid tests were performed at the proper times during the patient care. Values for the metrics from step 1203 may be determined from the comparison. Also, aggregated metrics may be determined for the population, such as mortality rates, compliance rates, percentage cured, etc.

At 1207, reports of the evaluation are generated by the CQA system 100. The reports may specify the metrics and analytic views of the metrics that allow for drill downs, such as described with respect to FIGS. 8-11. The reports may specify compliance variances from the protocol according to the process map. The reports may include an outcome variance analysis, a driver node analysis, a cost opportunity analysis and a driver node cost analysis. The reports may also include scorecard measures for the metrics. The reports may also include KPIs defined along with primary and secondary metrics.

Some or all of the method and operations and functions described above may be provided as machine readable instructions, such as a computer program, stored on a computer readable storage medium, which may be non-transitory such as hardware storage devices or other types of storage devices. For example, they may exist as program(s) comprised of program instructions in source code, object code, executable code or other formats. An example of a computer readable storage media includes a conventional computer system RAM, ROM, EPROM, EEPROM, and magnetic or optical disks or tapes.

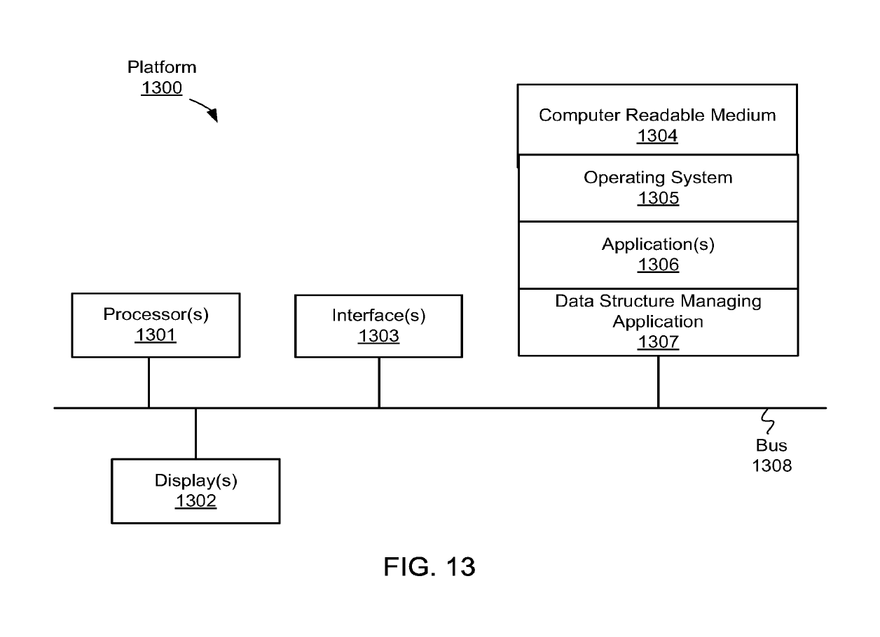

Referring to FIG. 13, there is shown a computer platform 1300 for the CQA system 100. It is understood that the illustration of the platform 1300 is a generalized illustration and that the platform 1300 may include additional components and that some of the components described may be removed and/or modified without departing from a scope of the platform 1300. Also, the CQA system 100 may be implemented in a distributed computing system, such as a cloud system.

The platform 1300 includes processor(s) 1301, such as a central processing unit, ASIC or other type of processing circuit; a display 1302, such as a monitor; an interface 1303, such as a simple input interface and/or a network interface to a Local Area Network (LAN), a wireless 802.11x LAN, a 3G or 4G mobile WAN or a WiMax WAN; and a computer-readable medium 1304. Each of these components may be operatively coupled to a bus 1138. A computer readable medium (CRM), such as CRM 1304 may be any suitable medium which participates in providing instructions to the processor(s) 1301 for execution. For example, the CRM 1304 may be non-volatile media, such as a magnetic disk or solid-state non-volatile memory or volatile media. The CRM 1304 may also store other instructions or instruction sets, including word processors, browsers, email, instant messaging, media players, and telephony code.

The CRM 1304 may also store an operating system 1305, such as MAC OS, MS WINDOWS, UNIX, or LINUX; applications 1306, network applications, and a data structure managing application 1307. The operating system 1305 may be multi-user, multiprocessing, multitasking, multithreading, real-time and the like. The operating system 1305 may also perform basic tasks such as recognizing input from the interface 1303, including from input devices, such as a keyboard or a keypad; sending output to the display 1302 and keeping track of files and directories on CRM 1304; controlling peripheral devices, such as disk drives, printers, image capture device; and managing traffic on the bus 1308. The applications 1306 may include various components for establishing and maintaining network connections, such as code or instructions for implementing communication protocols and performing functions of the CQA system 100.

A data structure managing application, such as data structure managing application 1307 provides various code components for building/updating a computer readable system (CRS) architecture, for a non-volatile memory, as described above. In certain examples, some or all of the processes performed by the data structure managing application 1307 may be integrated into the operating system 1305. In certain examples, the processes may be at least partially implemented in digital electronic circuitry, in computer hardware, firmware, code, instruction sets, or any combination thereof.

While the embodiments have been described with reference to the disclosure above, those skilled in the art are able to make various modifications to the described embodiments without departing from the scope of the embodiments as described in the following claims, and their equivalents.

What is claimed is:

1. A clinical quality analytics (CQA) system comprising:
a process map toolset to determine a process map from a protocol for medical treatment guidelines;
a mapping module to format electronic medical record (EMR) data to map the formatted EMR data to the process map;
a measurement and evaluation module to determine metrics to evaluate a quality of care associated with the protocol and to determine a population of the EMR data to use for the evaluation; and
a CQA engine to evaluate the population of EMR data for compliance with the protocol based on the metrics and mapping of the formatted EMR data in the population to the process map.

2. The CQA system of claim 1, wherein the process map toolset is to display the process map, and the process map toolset is to receive modifications to the displayed process map and to store the modified process map.

3. The CQA system of claim 1, wherein the process map comprises a time-based series of events determined from the protocol to render care according to the guidelines, and the process map includes attributes for the events, wherein the attributes include at least some of event type, time, location and caregiver.

4. The CQA system of claim 1, wherein the mapping module formats the EMR data by organizing the EMR data temporally to create a temporal process model, and the mapping comprises matching information in the temporal process model to events in the process map starting from a starting point in the process map and continuing the matching following a workflow in the process map.

5. The CQA system of claim 4, wherein the matching uses information data mined from the unstructured data using data elements defined by the measurement and evaluation module, wherein the data mining comprises receiving the data elements comprising one or more keywords related to an event in the process map, and searching the unstructured EMR data for the one or more keywords.

6. The CQA system of claim 1, wherein the measurement and evaluation module determines the population by receiving filters for defining the population, and filtering the EMR data according to the filters to determine the population.

7. The CQA system of claim 1, wherein the CQA engine evaluates the population of EMR data by comparing EMR data from the population to each event in the process map.

8. The CQA system of claim 1, comprising a user interface providing reports of the evaluation, wherein the reports indicate at least one of the metrics, analytic views of the metrics that allow for drill downs to identify causes of compliance failures, and a percentage of compliance with the protocol for the population.

9. A method of evaluating compliance with a protocol for medical treatment guidelines, the method comprising:
receiving the protocol for medical treatment guidelines;
determining a process map from the protocol;
formatting electronic medical record (EMR) data;
determining metrics to evaluate the quality of care associated with the protocol;
determining a population of the EMR data to use for the evaluation; and
evaluating, by a processor, the population of EMR data for compliance with the protocol based on the metrics and based on a mapping of the formatted EMR data in the population to the process map.

10. The method of claim 9, wherein determining a process map from the protocol comprises associating attributes associated with the protocol to events in the process map.

11. The method of claim 9, wherein determining a process map comprises:
generating an initial process map from the protocol based on steps identified from the protocol;
receiving modifications to the initial process map; and
storing the process map including the modifications.

12. The method of claim 9, wherein the process map comprise a time-based series of events determined from the protocol to render care according to the guidelines.

13. The method of claim 9, wherein the formatted EMR data is organized temporally to create a temporal process model, and the method further comprises mapping the formatted EMR data in the population by
matching information in the temporal process model to events in the process map starting from a starting point in the process map and continuing the matching following a workflow in the process map.

14. The method of claim 13, comprising:
data mining unstructured data in the EMR data; and
performing the matching using information data mined from the unstructured data.

15. The method of claim 14, wherein the data mining comprises:
receiving one or more keywords related to an event in the process map; and
searching the EMR data for the one or more keywords.

16. The method of claim 9, wherein determining metrics to evaluate the quality of care comprises receiving definitions for at least one of the metrics.

17. The method of claim 9, wherein determining a population of the EMR data to use for the evaluation comprises:
receiving filters for defining the population; and
filtering the EMR data according to the filters to determine the population.

18. The method of claim 9, wherein evaluating the population of EMR data for compliance with the protocol comprises comparing EMR data from the population to each event in the process map.

19. The method of claim 9, comprising:
generating reports of the evaluation, wherein the reports indicate at least one of the metrics, analytic views of the metrics that allow for drill downs to identify causes of compliance failures, and percentage of compliance with the protocol for the population.

20. A non-transitory computer readable medium including machine readable instructions that when executed by a processor perform instructions to:
receive a protocol for medical treatment guidelines;
determine a process map from the protocol;
format electronic medical record (EMR) data;
determine metrics to evaluate the quality of care associated with the protocol;
determine a population of the EMR data to use for the evaluation; and
evaluate the population of EMR data for compliance with the protocol based on the metrics and based on a mapping of the formatted EMR data in the population to the process map.
